(19) United States
(12) Patent Application Publication
(10) Pub. No.: US 2009/0278848 A1
(43) Pub. Date: Nov. 12, 2009

(54) DRAWING FAMILIAR GRAPHS WHILE SYSTEM DETERMINES SUITABLE FORM

(75) Inventors: George G. Robertson, Seattle, WA (US); Joshua Wyndham Lee, Redmond, WA (US); Brian Scott Ruble, Redmond, WA (US); Christian Bernd Schormann, Seattle, WA (US); William Guthrie Morein, Cambridge, MA (US); Jason Joseph Weber, Burlington, IA (US); Benjamin L. Chronister, Duvall, WA (US); Danyel A. Fisher, Seattle, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/118,887

(22) Filed: May 12, 2008

(51) Int. Cl. G06T 11/20

(52) U.S. Cl. 345/440.2; 345/440

(57) ABSTRACT

A graphical user interface system is provided. The system includes a graphical component to enable sketching of a diagram and a logical component to associate one or more data sources with the diagram. A visualization component adjusts the diagram in accordance with the one or more data sources.

### BACKGROUND

Modern graphical drawing systems have automated many of the burdens associated with older graphical forms such as computing data points of a graph, manually laying out the points on a paper, and then graphing the points to form a desired view of the data. Many are familiar with Computer Aided Design (CAD) software that allows users to select or define shapes for a computer drawing surface. The shapes can then be manipulated and easily connected to draw substantially any form or outline. In one form, the computer is sometimes employed for sketching which is often a great way to communicate ideas with the implicit knowledge that the idea is in the formative stages. The rapid ability to generate an image has many advantages. Speed is high because one is using approximate visual images with simple tools (e.g., pencil and paper, simple computer drawing package). There is no need for precision or specialized knowledge and, in fact, precision can confuse a viewer into thinking that an idea is more complete and immutable than it actually is. Also included is the ease of low-level correction and revision. Most three-dimensional (3D) computer modeling systems are efficient at generating arbitrary views of precise 3D models and support high-level editing and revision.

An application referred to as SKETCH attempts to combine the advantages of both hand-drawn-representation and precise computer modeling in order to create an environment for rapidly conceptualizing and editing approximate 3D scenes. To achieve this, the application uses simple non-photorealistic rendering and a purely gestural interface that is based on simplified line drawings of primitives and allows all operations to be specified within the 3D world. While such tool is efficient for generating images, it does not address the need for more complex mathematical modeling such as generating a graphical view of data. Thus, although efficient at sketching images, the 3D tool does not address how data is associated with an image nor does it address charting or other diagrammatic displays that are in fact a function of some data relationship.

Referring to another type of graphical tool, timeline visualization is generated where an overall view can be provided on a series of data and the user can identify portions of the series for further analysis. Thus, there is widespread interest in discovering features and trends in time-series that have generated a need for tools that support interactive exploration. In one example, a prototype tool has been constructed for interactive querying and exploration of time-series data. Queries are built using time-boxes: a powerful graphical, direct-manipulation metaphor for the specification of queries over time-series datasets. The time-boxes support interactive formulation and modification of queries, thus speeding the process of exploring time-series data sets and guiding data mining. The prototype tool includes windows for time-box queries, individual time-series, and details-on-demand. Other features include drag-and-drop support for query-by-example and graphical envelopes for displaying the extent of the entire data set and result set from a given query.

Time-boxes are rectangular widgets that can be used in direct-manipulation graphical user interfaces (GUIs) to specify query constraints on time series data sets. Time-boxes are utilized to specify simultaneously two sets of constraints: given a set of N time series profiles, a time-box covering time periods x1 . . . x2 (x1rx2) and values y1 . . . y2(y1ry2) will retrieve only those data that have values y1ryry2 during all times x1rxrx2. A related tool—Time Searcher is an information visualization tool that combines time-box queries with overview displays, query-by-example facilities, and support for queries over multiple time-varying attributes. Query manipulation tools including pattern inversion and ‘leaders & laggards’ graphical bookmarks provide additional support for interactive exploration of data sets. While allowing further analysis along a time series data set, this tool does not associate data with a diagram nor does it adjust the diagram in view of data that may have been located outside of the analytical process. Thus, basically static time-series analysis is employed which is not useful to more complicated graphical design that requires data to both fit and shape a desired graphical view.

In yet another example graphical system, a tool is provided that allows analysis for a line graph associated with time series data. Sequential data is easily understood through a simple line graph, yet systems to search such data typically rely on complex interfaces or query languages. The tool includes an application referred to as Query Sketch, which is a financial database application for which graphs are used for query input as well as output. The Query Sketch application allows users to sketch a graph freehand, and then view stocks whose price histories match the sketch. Using the same graphical format for both input and output, results in an interface that is powerful, flexible, yet easy to use. Unfortunately however, although the Query Sketch application can search for data associated with the sketch, the sketch itself is never manipulated in view of the retrieved data. Thus, as a graphical design tool for the diagram, the tool lacks the sophistication to utilize the data in a more suitable visual form i.e., use the located data to update the sketch itself.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Automated tools are provided to allow users to easily construct desired charts or diagrams while mitigating the need to understand the more complex mechanics in creating such charts or diagrams. In one aspect, a user sketches or gestures on a graphical user interface surface the rough outlines of a desired drawing or graph. The surface could be a conventional desktop display to more elaborate forms such as a projected wall surface where a hand gesture indicates an outline or hint as to the type of chart the user has in mind. After a rough sketch has been made, one or more data sources are analyzed to determine prospective data categories or data that may fit with the desired view sketched by the user. Heuristics or other intelligent inferences can be employed to determine which data from the respective sources may be applicable to the view outlined by the user on the graphical surface.

Users can direct a logical component to a specific source for the data where further analysis can be conducted to determine a potential fit for the data to the desired view identified by the user. Hints such as category labels for data or the shape of the diagram itself can allow inferences to be made by the logical component as to the source of the actual data and the graphical nature expected in the final output display. After the data has been identified for a respective chart, the chart is adjusted or mapped in view of the data to produce a final graphical shape or image that depicts the desired presentation identified or hinted at by the user.

In one basic example, if a circle is drawn, it may be inferred that a Pie style chart is being identified by the user. Data may then be analyzed by the logical component to determine which categories of data are identified for the chart. For example, the user may identify four quadrants of the circle with different category names, where the logical components then scan the respective data sources for the category names. In another example, if the user draws pie slices, the system can automatically pull data based on the slice size. Upon locating the category names, the data identified by the categories is then associated with the respective chart. For instance, if the categories were the population of cities A, B, C, and D, and city A was 50 percent of the total population for the four cities identified, then the Pie chart would be adjusted to show half of the Pie occupied and identified by a label (or other identifier such as color) associated with city A. As the data for the other three cities B-D was located, the Pie chart could be updated and adjusted accordingly in view of the respective data. By allowing users to indicate their intentions via a rough sketch or outline, and having the system generate the final diagram view and automatically updated by the respective data sources, users are relieved of the burden of having to both define a desired view and understand the more complicated mathematical mechanisms for generating such views.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a graphical user interface system for generating diagrams and automatically updating and associating data with the diagrams.

FIG. 2 is a block diagram that illustrates example charting options.

FIG. 3 is a flow diagram that illustrates a graphical interface and diagramming process.

FIG. 4 illustrates a generic graphical user interface tool for rendering visualizations.

FIG. 5 illustrates a surface tool for rendering visualizations.

FIG. 6 illustrates a system for processing user gestures.

FIG. 7 illustrates an exemplary system for inferring data sources for a respective diagram.

FIG. 8 illustrates an example system for generating visualizations.

FIG. 9 illustrates an example visualization.

FIG. 10 is a schematic block diagram illustrating a suitable operating environment.

FIG. 11 is a schematic block diagram of a sample-computing environment.

### DETAILED DESCRIPTION

Systems and methods are provided to enable users to draw or gesture a rough outline for a chart or diagram while an automated system determines and generates data for the respective chart or diagram. As data is determined and associated with the diagram, the diagram is adjusted or shaped in view of the data. In one aspect, a graphical user interface system is provided. The system includes a graphical component to enable sketching of a diagram and a logical component to associate one or more data sources with the diagram. A visualization component adjusts the diagram in accordance with the one or more data sources (e.g., visually conforms the diagram to the data).

As used in this application, the terms “component,” “interface,” “diagram,” “visualization,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

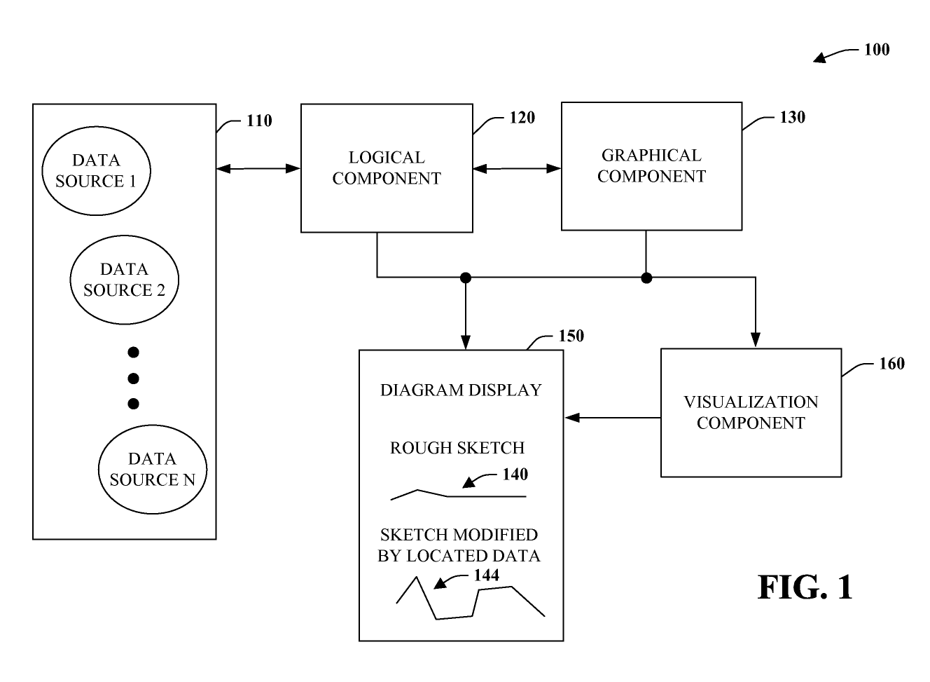

Referring initially to FIG. 1, a graphical user interface system 100 is illustrated for generating diagrams and automatically updating and associating data with the diagrams. One or more data sources 110 are analyzed by a logical component 120, where a graphical component 130 is employed to render a rough sketch 140 and a modified sketch 144 at a diagram display 150. In general, the graphical component can be a desktop touch screen input, a mouse controlled input display, a gesture-based display, a projection surface or substantially any input device to allow a user to draw or provide gesture that indicates the rough sketch 140. The rough sketch 140 can be substantially any graphical form that is representative of a data set including charts, graphs, diagrams, pie charts, bar charts, linear charts, non-linear graphs, and so forth.

After the rough sketch 140 is entered by the user via the graphical component 130 and rendered at the display 150, the logical component 120 attempts to identify the type of graph or chart that is rendered by the user and analyzes the data sources 110 to locate data that is suitable for the sketch 140. Upon locating the data (via heuristics or inferences described below), the logical component 120 notifies a visualization component 160 to produce a final rendering which is the sketch 144 modified by the located data. Thus, not only is data located that is a potential match for the rough sketch 140, but the located data is employed to alter the view of the rough sketch and provide the actual or modified view of the data at 144.

The system 100 can be provided as automated components in conjunction with a computing system that allows users to easily construct desired charts or diagrams at 150 while mitigating the need to understand the more complex mechanisms in creating such charts or diagrams. In one aspect, a user sketches or gestures on a graphical user interface surface 130, where the rough outlines of a desired drawing or graph 140 are displayed at 150. The surface 130 can drive a conventional desktop display 150 or drive more elaborate forms such as a projected wall surface (described below) where a hand gesture indicates an outline or hint as to the type of chart 140 the user has in mind. After a rough sketch 140 has been made, one or more data sources 110 are analyzed to determine prospective data categories or data that may fit with the desired view sketched by the user. Heuristics or other intelligent inferences can be employed to determine which data from the respective sources 110 may be applicable to the view outlined by the user on the graphical surface 130 and associated display 150.

Users can direct the logical component 120 to a specific source for the data 110 where further analysis can be conducted to determine a potential fit for the data to the desired view identified by the user. Hints such as category labels for data or the shape of the diagram itself can allow inferences to be made by the logical component 120 as to the source of the actual data and the graphical nature expected in the final output display. After the data has been identified for a respective chart, the chart is adjusted or mapped at 144 via the visualization component 160 in view of the data to produce a final graphical shape or image at 144 that depicts the desired presentation identified or hinted at by the user via the sketch 140.

In one example, if a bar graph is drawn at 140 with three columns (or three rows), it may be inferred that a bar style chart is being identified by the user. Data 110 may then be analyzed by the logical component 120 to determine which categories of data are identified for the chart. For example, the user may identify three sectors of the graph with different category names (or other identifiers such as numbers, colors, and so forth), where the logical component 120 then scans the respective data sources 110 for the category names. Upon locating the category names, the data identified by the categories is then associated with the respective chart or graph. For instance, if the categories were the batting averages of players P1, P2, and P3, and P1 was 20 points higher than the averages identified for the other players, then the bar chart would be adjusted to show one of the columns occupied and identified by a label (or other identifier such as color) associated with player P1, where P1's column would be adjusted higher in a visual scaling of the graph at 144.

As the data for the other players is located, the bar chart could be updated and adjusted accordingly in view of the respective data. By allowing users to indicate their intentions via the rough sketch 140 or outline, and having the system generate the final diagram view 144 that is automatically updated by the respective data sources 110, users are relieved of the burden of having to both define a desired view and understand the more complicated mechanisms for generating such views.

The data 110 can be received from one or more data sources or can be located within a data source that has multiple segments, categories, or other designations. Such data 110 can be collected from wireless sources, local or remote data sources, and public or private networks such as the Internet for example. The views 144 can be substantially any display or output type including graphs, charts, trees, multi-dimensional depictions, images (computer generated or digital captures), video/audio displays describing the data 110, hybrid presentations where output is segmented into multiple display areas having different data analysis in each area and so forth. It is noted that data for the system 100 can be gleaned and analyzed from a single source or across multiple data sources 110, where such sources can be local or remote data stores or databases. This can include files or data structures that maintain states about the user (or other entities such as corporations) and can be employed to determine future states. These can be past action files for instance that store what a user has done in the past and can be used by intelligent components such as classifiers to predict future actions.

Heuristics or inferences can be provided by the logical component 120 to locate data for the rough sketch 140 and to facilitate mapping of the data to a final rendering of at sketch 144. In one example, the shape of the rough sketch is analyzed to determine the final rendering. As noted previously, a circle may be indicative of a pie chart, a line may indicate a linear relationship, whereas a table may indicate a row and column database structure. If the user labels axis of the chart or rows and columns for example, the data sources 110 can be searched for the labels which in turn can indicate how the chart or diagram should appear and how the data should map into the respective chart or diagram. The heuristics may also determine the final shape or appearance of the sketch 144.

Data clusters can be observed and used to map between the visual diagram and the data which may be linked to the diagram. For example, if eight clusters are found in the data sources, the clusters may provide a hint that should be linked to eight tree nodes outlined by the rough sketch 140. More elaborate inferences can also be employed to determine chart/data mappings and will be described in more detail below. In another aspect, a visualization system 100 is provided. The system includes means for rendering a generic outline of a diagram (graphical component 130) and means for mapping one or more data sources to the diagram (logical component 120). The system also includes means for generating a finalized diagram from the mapped data sources (visualization component 160).

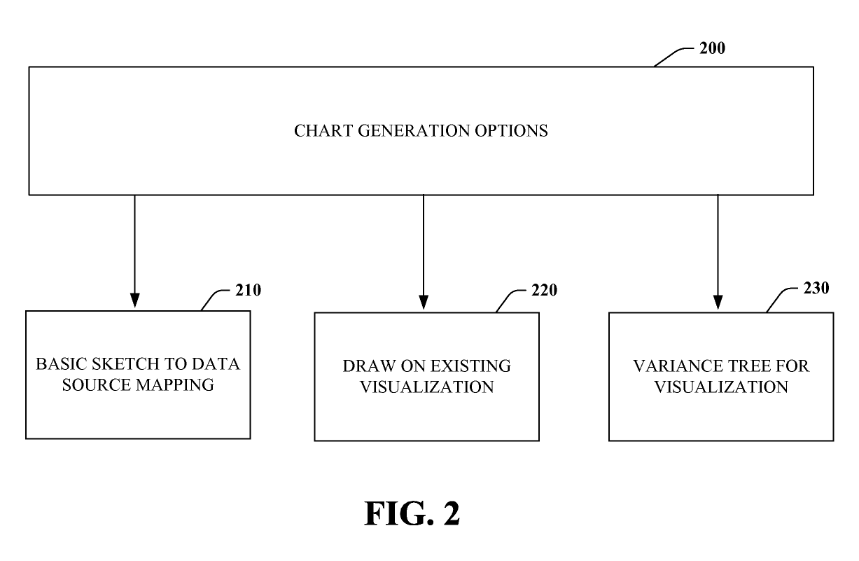

Referring now to FIG. 2, example chart generation options 200 are illustrated. At 210, basic sketch to data mapping is provided. One challenge current users have is figuring out how to use present day user interface tools. Thus, automated mapping allows users to define a visualization they are familiar with and then have an application map the desired visualization into a manageable form. In one example, users can sketch a representation of a desired chart. The application would then use heuristics or another technique such as inference to detect the user's intent, and map the user's data into a form the application understands to build further visualizations or data clusters. Thus, a person can use a surface device to draw a line or axis. The application would then use heuristics to determine the chart type they were attempting to draw, and employ some other type of gesture to combine/map the chart with a data source. The application could also annotate the chart in a very free form manner. The application may also allow a user to select a data source object and drop it onto a sketched axis, and a tool would automatically bind the data source and chart.

At 220, an existing visualization can be drawn upon and subsequently expanded. For example, an object the user wants to observe, and regenerate the data from the object, or instruct the system what user wants to see e.g., draw a line graph and axis and cause the tool to generate or retrieve the data for the desired view of the graph and the respective axis. At 230, a variance tree for visualization can be provided where one creates a visualization or diagram and let the tool determine what action to perform next. For instance, create a variant tree for visualization providing different paths and branches for possible visualization outcomes, where the steps the user performs, the tool branches out and creates possible variations from the previous selections/visualization decisions. This allows users to visually choose what is the most promising visualization going forward. Also, the tool can allow users to select a branch, observe how it looks with given options and select another branch if they are not pleased with a given visualization. The system automatically creates a set of variants that can be employed for visualizations. Options could be provided on a very large screen e.g., provide a plurality of visualization options at each successive decision branch. This option allows users to observe potential graphical options as feedback from the system, pare down or remove non-desirable options, before proceeding with intermediate or finalized graphical renderings.

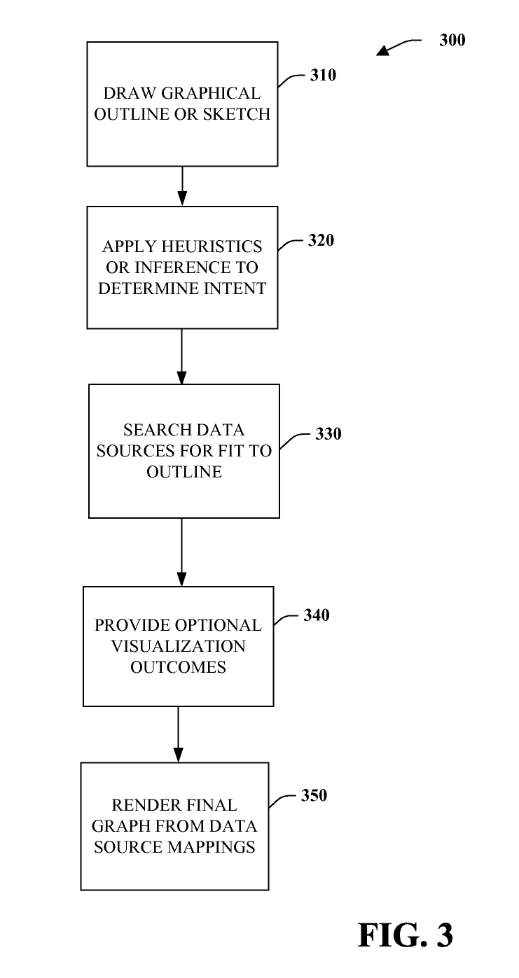

Referring now to FIG. 3, a graphical interface and diagramming process is illustrated. While, for purposes of simplicity of explanation, the process is shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Turning to FIG. 3, an example process 300 is illustrated that performs automated data to sketch mapping and rendering. Proceeding to 310, graphical rendering tool is employed to draw a rough sketch or outline of a potential graph or chart to be rendered. These can include linear graphs, tables, charts, multi-dimensional depictions, and substantially any form that is capable of being rendered according to a data set. At 320, heuristics or inferences are employed to determine the user's intent when rendering the sketch or outline. This can include taking clues from labels, indicia, or other makings the user may apply to the outline or include a shape analysis of the outline itself.

At 330, data sources are searched to find a fit of data for the outline or sketch. Sources can include databases, remote network nodes, Internet sites, files, data structures, objects, or other memory locations. At 340, one or more visualization options can be provided to the user. This can include variance trees or other options that illustrate potential visualization outcomes from the user, where the user can select one or more possible branches to guide the final rendering of the graph or chart. At 350, after a data source has been located and mapped to the determined graph, a final rendering is generated for output to the user, where the located data adjust or configures the final rendering to have the actual contours and shape of the located data.

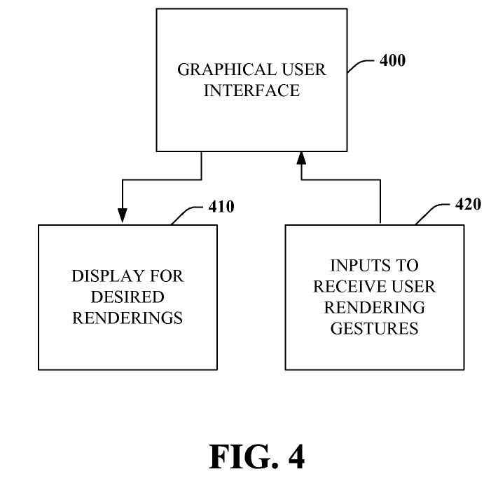

Referring now to FIG. 4, a generic user interface tool 400 for rendering visualizations is illustrated. As shown the tool 400 includes a display 410 to view the user's rough sketches and finalized renderings. The display 410 can be a mobile display such as on a cell phone or other mobile device or more elaborate display such as a surface tool which is described in more detail below. The tool 400 also includes various inputs 420 to receive user gestures such as hand or stylus movements indicating a graph or voice or keyboard commands indicating a category or label. The tool includes controls that can be updated in several instances and likely via a user interface that is served from a remote server or on a respective mobile device if desired. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI or tool 400 can include the display 410 having one or more display objects (not shown) for manipulating the renderings including such aspects as configurable icons, buttons, sliders, input boxes, selection options, menus, tabs and so forth having multiple configurable dimensions, shapes, colors, text, data and sounds to facilitate operations with the tool. In addition, the GUI or tool 400 can also include a plurality of other inputs 420 or controls for adjusting, manipulating, and configuring one or more aspects. This can include receiving user commands from a mouse, keyboard, speech input, web site, remote web service and/or other device such as a camera or video input to affect or modify operations of the GUI. For example, in addition to providing drag and drop operations, speech technologies can be employed to control when or how data is presented to the user. The renderings can be updated and stored in substantially any data format.

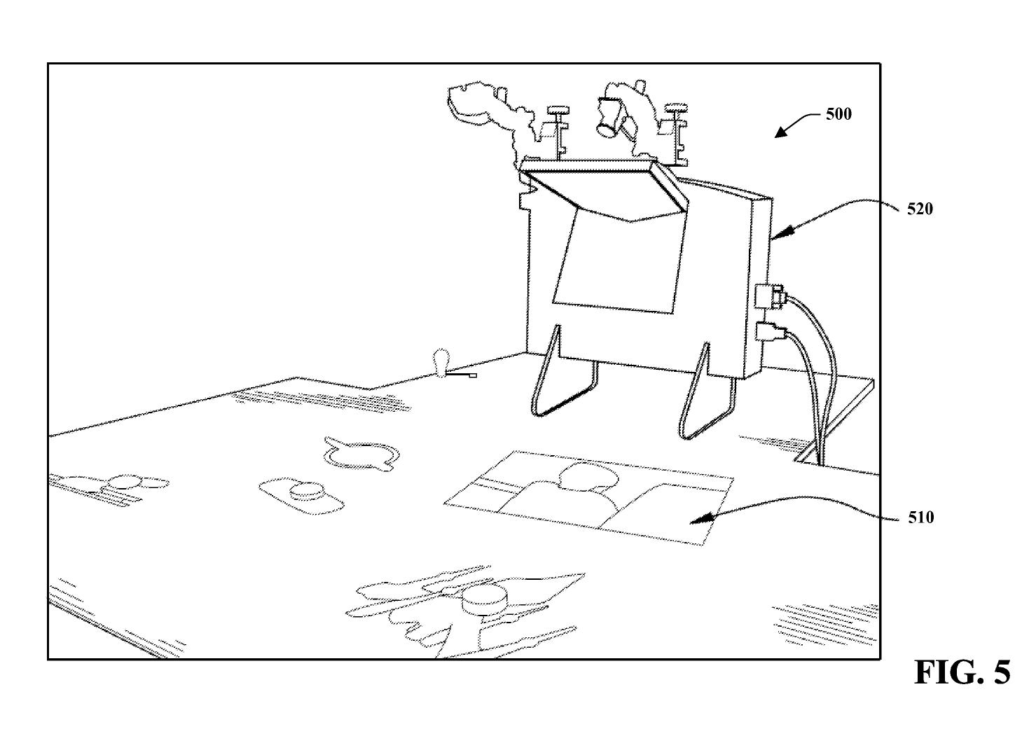

Referring now to FIG. 5, a surface tool 500 for rendering data is illustrated. Interactive surfaces are often equipped with sensors to detect the user's touch, and many also have the ability to detect the presence of other physical objects. Computer vision is one example technique that is useful in the location, tracking and identification of objects drawn or placed on a computer vision surface. The computer vision surface employs a projector and vision-based sensing for compact interactive surface applications. This can include an infrared-sensitive camera and infrared illuminant to monitor the user's gestures and the drawing of objects on an everyday surface such as an office desk or wall such as illustrated at 510 of FIG. 5. A camera can be positioned and calibrated to monitor an active display area of a projector 520, such that when objects are detected by vision processes, the system may then display graphics that are registered with the physical object or rendering. Since the camera senses near-infrared light (approximately 900 nm, just beyond visible, and not impacted by heat sources), the sensed image does not include the projected image composed of only visible light.

Computer vision systems exploit the flexibility that modality affords. For example, it is straightforward to detect the placement or drawing of objects on the surface by comparing the most recent image of the surface with a reference image of the empty surface at 510. This can be achieved by computing the pixel-by-pixel difference between a reference image and current image. Pixel differences that are greater than a pre-determined threshold are marked in a new image as ‘1’ while others can be marked as ‘0’. Following this binarization process, connected components analysis then groups sets of adjacent pixels with value ‘1’, yielding a rough list of the spatially distinct objects on the surface 510. This process can be repeated for substantially every frame at a rate of 30 Hz. In conjunction with the connected component analysis algorithm, various statistics about the shape of each object may be computed. For example, geometric moments (mean, covariance) of the connected component pixel locations may be computed to determine an ellipse fit to the connected component, giving a rough indication of the size and orientation of the object drawn, placed, or rendered on the surface.

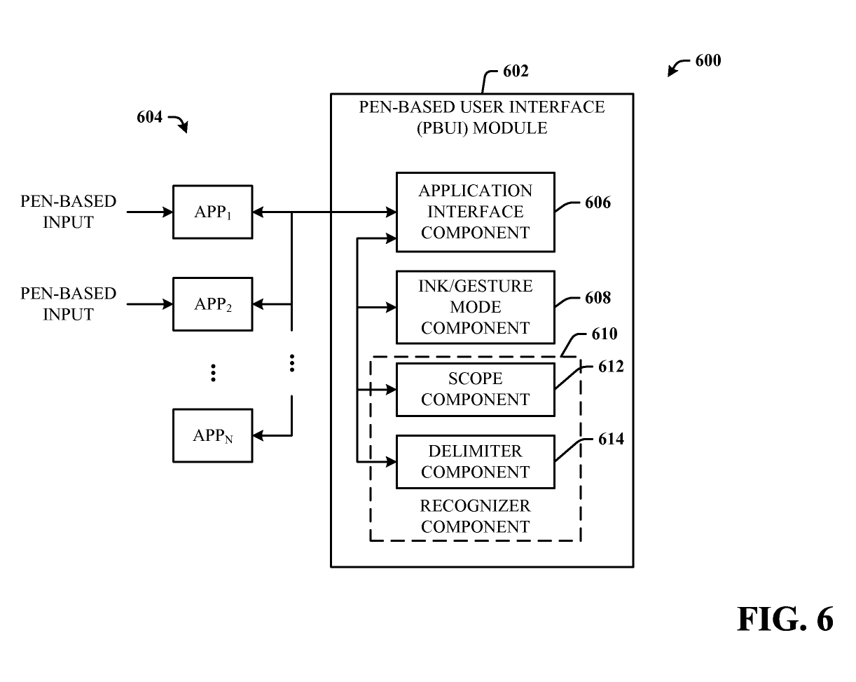

Referring to FIG. 6, a system 600 can be employed for processing user gestures. The system 600 includes a pen-based user interface module (PBUI) module 602 that provides drawing capabilities for pen-based processing. As noted above, hand or other non-pen gestures can also be employed for drawing or sketching graphs. The module 602 facilitates interfacing with any or all of a plurality of applications 604 (denoted APP1, APP2, . . . , APPN) that can be hosted on a computing system (or device). Typically, each of the applications 604 is suitably designed to receive pen-based input. However, this is not a requirement of the system 600, as some of the applications 604 may not be suitable for pen-based input, and can instead employ the techniques of other pointing devices, such as mice or touch pads.

The PBUI module 602 includes an application interface component 606 that provides interfacing to any of the applications 604 designed for pen-based input. For example, the application APP1 can be an operating system of a pen-based device on which the PBUI module is installed. The PBUI module 602 also includes an Ink/Gesture mode component 608 that facilitates receiving input which alternates between Ink mode and Gesture mode. A recognizer component 610 provides the capability to recognize the pen-based input sketched by a user. In support thereof, the recognizer component 610 further comprises a scope component 612 that facilitates scope processing in accordance with simple and complex scopes. As well, the recognizer component 610 includes a delimiter component 614 that processes delimiters for a respective rendering.

It is noted that is it to be appreciated by one skilled in the art that the components (606, 608, 610, and 612) can be combined in any suitable manner, insofar as the capabilities of the PBUI are maintained. For example, the Ink/Gesture component 610 can be combined with the scope component 610. Similarly, the scope component 610 and the delimiter component 612 can be combined into a single component, and which single component is external to the PBUI module 602. It is further to be appreciated that although the description is focused on a pen-based architecture, such user interaction can be by different input devices, for example, a mouse, trackball with buttons, and so forth.

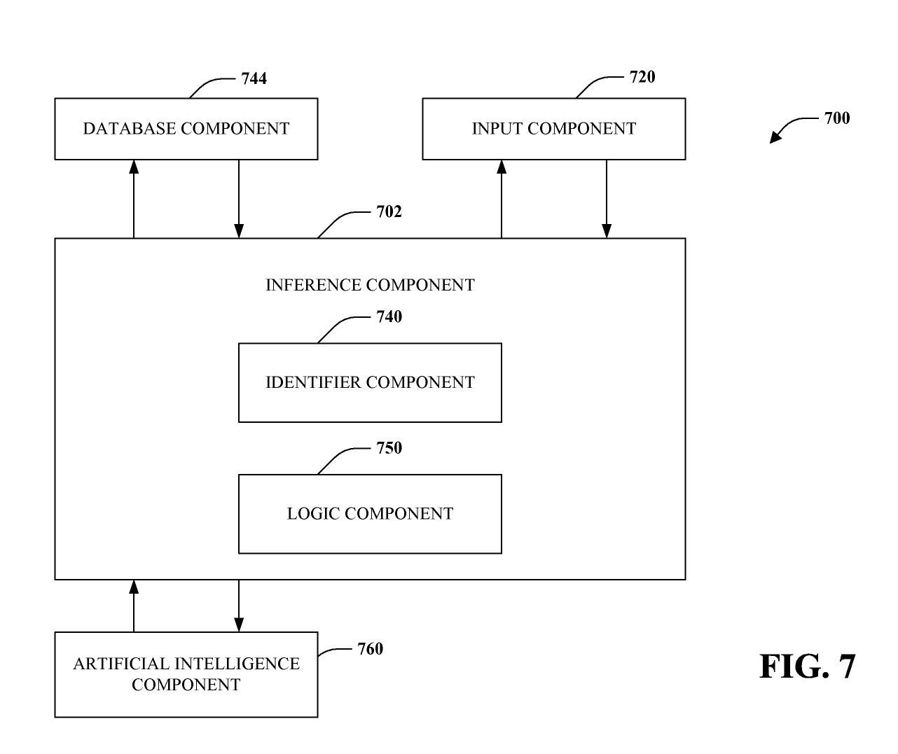

Turning now to FIG. 7, an exemplary system 700 is provided for inferring visualizations from a data source. An inference component 702 receives a set of parameters from an input component 720. The parameters may be derived or decomposed from a specification provided by the user and parameters can be inferred, suggested, or determined based on logic or artificial intelligence. An identifier component 740 identifies suitable control steps, or methodologies to accomplish the determination of a particular data item (e.g., observing a data pattern and determining a suitable visualization). It should be appreciated that this may be performed by accessing a database component 744, which stores one or more component and methodology models. The inference component 702 can also employ a logic component 750 to determine which data component or model to use when analyzing data and determining a suitable visualization there from. As noted previously, classifiers or other learning components can be trained from past observations where such training can be applied to an incoming data stream. From current received data streams, future predictions regarding the nature, shape, or pattern in the data stream can be predicted. Such predictions can be used to augment visualizations as previously described.

When the identifier component 740 has identified the components or methodologies and defined models for the respective components or steps, the inference component 702 constructs, executes, and modifies a visualization based upon an analysis or monitoring of a given application or data source. In accordance with this aspect, an artificial intelligence component (AI) 760 automatically generates data by monitoring or searching data sources. The AI component 760 can include an inference component (not shown) that further enhances automated aspects of the AI components utilizing, in part, inference based schemes to facilitate inferring data from which to augment an application. The AI-based aspects can be affected via any suitable machine learning based technique or statistical-based techniques or probabilistic-based techniques or fuzzy logic techniques. Specifically, the AI component 460 can implement learning models based upon AI processes (e.g., confidence, inference). For example, a model can be generated via an automatic classifier system.

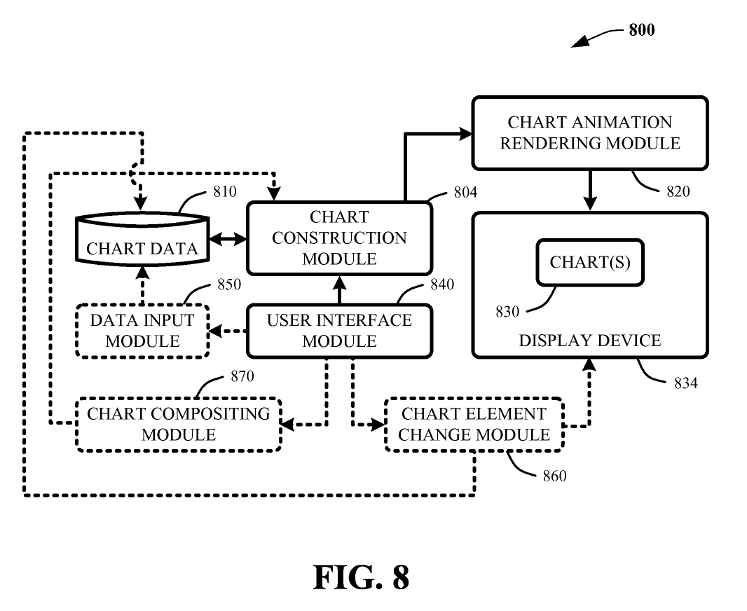

Referring to FIG. 8, an example system 800 is illustrated for generating visualizations. In general, a Charting Animator process generally begins operation by using a chart construction module 804 to define parameters used to construct one or more charts (e.g., Pie Charts, Bar Charts, Line Charts, Area Charts, Plateau Charts, etc.) using one or more sets of chart data 810. The chart construction module 804 then provides these parameters to a chart animation rendering module 820 which renders chart(s) 830 on a display device 834 (or surface).

When the chart(s) 830 have been rendered on the display device 804, changes to the rendered chart(s) are enabled using any of several aspects. For example, in one aspect, a user interface module 840 is utilized to modify one or more of data elements comprising the chart data 810 via a data input module 850. Modifications to these data elements include changing the value of one or more of the data elements, adding one or more data elements, and deleting one or more data elements. In general, these data elements are maintained in a conventional computer readable format, such as, for example, in a list, table, database, and so forth. Consequently, direct modifications to the data elements by using a user interface to change the data elements via the data input module 850 can be accomplished using conventional techniques.

When data elements have been modified, the chart construction module 804 determines new chart parameters corresponding to the modified data elements, and passes those chart parameters to the chart animation rendering module 820. At this point, the chart animation rendering module 820 then morphs the existing charts(s) 830 into new chart(s) 830 using a dynamic animation that smoothly transitions from the existing chart(s) to the new chart(s) on the display device 834.

In another aspect, changes to the rendered chart(s) 830 are enabled by directly modifying one or more elements of the chart(s), such as, for example, resizing the height of one or more bars on a Bar Chart, or changing the size of a pie slice in a Pie Chart. In various aspects, direct modification of the elements of the chart(s) is accomplished via the user interface module 840 which allows the user to select one or more individual elements of one or more charts 830 using a graphical user interface provided via a chart element change module 860. This graphical user interface provides a graphical interface to chart(s) 830 being rendered on the display device 834 for resizing, moving, sorting, or deleting one or more of those chart elements. Similarly, chart elements can also be added to one or more of the chart(s) 830 via the graphical user interface provided by the chart element change module 860.

When any chart elements have been modified (by resizing, moving, sorting, deleting, adding, etc.), the chart element change module 860 then automatically modifies the corresponding data elements of the chart data 810 (or adds new values to the chart data) to fit changes made to the chart elements. For example, if a bar in a Bar Chart originally had a value of “10,” then that bar was resized via the chart element change module 860 to show a value of “5” on the display device 834, then the chart element change module can change the value of the corresponding data element to “5” in the chart data 810.

Depending upon the chart(s) being displayed, many of the chart elements are often interdependent. Consequently, changes to one data element (either via the data input module 850, or via the chart element change module 860) used to construct the chart will often have an effect either on other data values, or on the displayed chart(s) 830. For example, if a pie slice in a Pie Chart is deleted or resized, or the underlying data value is changed, the other slices in the Pie Chart can be resized so that the Pie Chart retains a full pie shape. Therefore, when a change to data elements of the chart data 810 occurs (by any mechanism described herein), the chart construction module 804 determines new chart parameters corresponding to the modified data elements, and passes those chart parameters to the chart animation rendering module 820. At this point, the chart animation rendering module 820 then morphs the existing charts(s) 830 into new chart(s) 830 utilizing a dynamic animation that smoothly transitions from the existing chart(s) to the new chart(s) on the display device 834

In yet another aspect, a chart compositing module 870 is accessed via the user interface module 840 for creating a composite chart from two or more existing charts 830. In general, the user can use the chart compositing module 870 to specify (or select from a predefined list) some mathematical relationship between two or more existing charts 830. This mathematical relationship is then used to construct a composite chart by passing composite chart parameters to the chart construction module which in turn passes those parameters to the chart animation rendering module which acts to render the composite chart on the display device as an animation that morphs the existing charts into the composite chart.

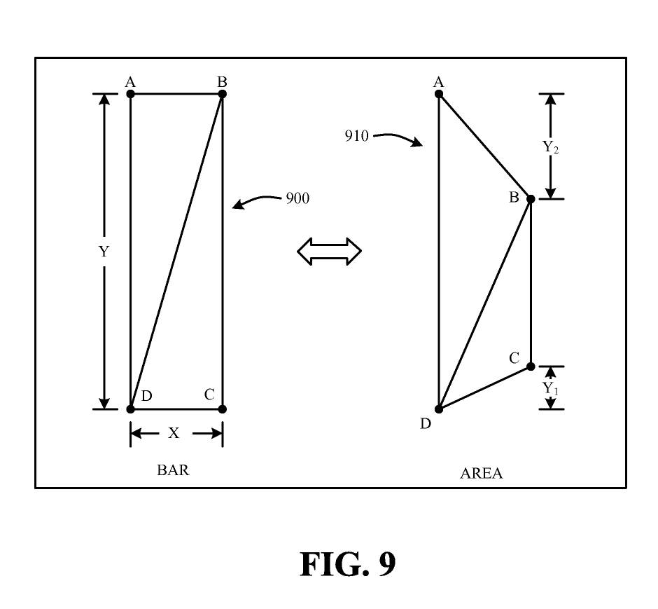

Referring to FIG. 9, an example visualization is illustrated. In general, the system 800 previously described has the ability to render chart elements of one shape into chart elements of another shape, such as, for example, morphing to or from a rectangle to a line segment, area segment, or pie slice. This morphing is generally achieved by moving existing points of the various chart elements to create the new shapes, then rendering intermediate shapes to create the animated transition. Further, in addition to moving points to define a new shape, various animation components introduce new points as needed. For example, a pie slice employs many more points than a rectangular bar of a Bar Chart; so, when transitioning from a bar to a pie slice, more points are added—and when transitioning away from a pie slice, those extra points are removed.

Changing the shape of chart elements from one shape to another, such as, for example, changing a rectangular bar of a Bar Chart to a polygon of an Area Chart, or changing a rectangular bar of a Bar Chart to a pie slice of a Pie Chart is achieved by smoothly morphing the chart element from the original shape to the new shape to provide an animated transition between the shapes. This morphing can be accomplished using any of a number of morphing techniques.

For example, in one aspect, as illustrated by FIG. 9, a rectangular bar of a Bar Chart is morphed into a polygon of an Area Chart. Note that this example is not intended to limit the way in which shapes are morphed, and is provided only as a simple illustration of shape morphing techniques that may be utilized by the various animation techniques described or inferred herein.

A rectangle 900 defined by corner points {A, B, C, D} is changed to polygon 910 by translating point B by offset Y2, and translating point C by offset Y2. Clearly, any of the four points of rectangle 900 can be translated in either the X or Y direction to provide the desired shape. Similarly, translating some or all of the points, depending upon the shape, is used for scaling the shape. For example, translating two or more of points A, B and C towards (or away from) point D can be used to scale the size of rectangle 900 either up or down. Further, any one of the four points of rectangle 900 can be collapsed into another of those points to create a triangle from the rectangle 900. In any case, once the points of the new shape have been determined, the animation from the original shape to the new shape is created by simply rendering a sequence of intermediate images in steps as small as one pixel for each point, over some period of time. As can be appreciated, a plurality of various shapes, forms, and associated dimensions can be morphed or transitioned from one shape or form to another.

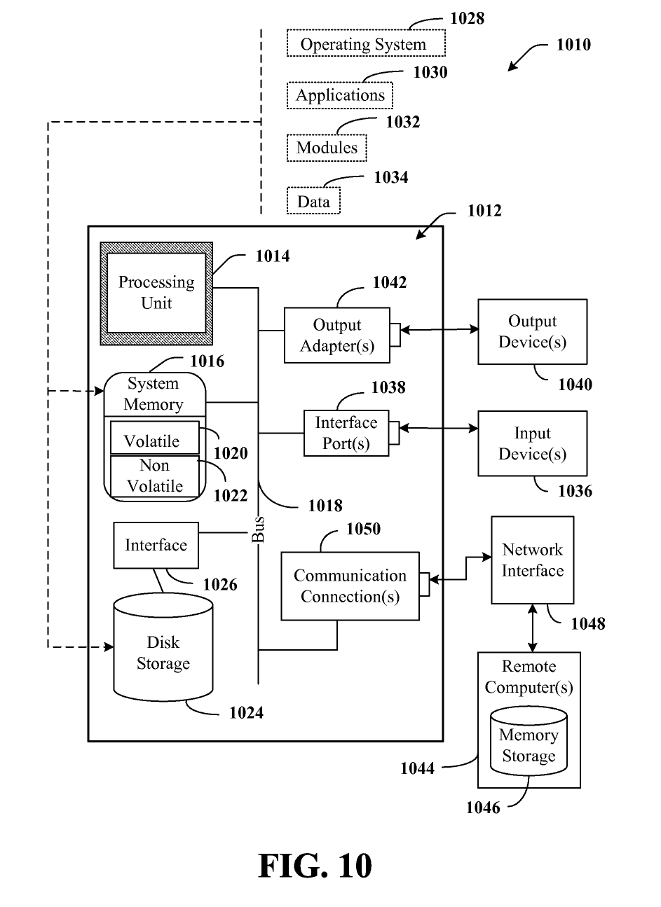

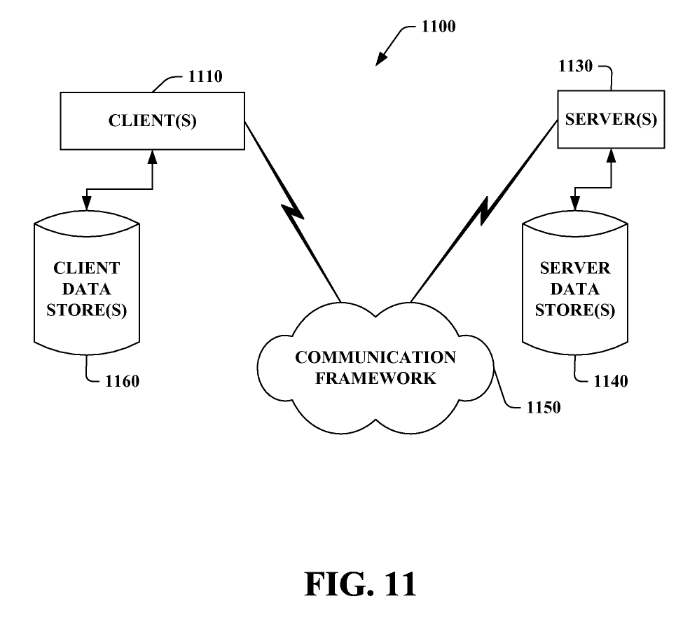

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 10, an exemplary environment 1010 for implementing various aspects described herein includes a computer 1012. The computer 1012 includes a processing unit 1014, a system memory 1016, and a system bus 1018. The system bus 1018 couple system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 64-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that various components described herein can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 that can be employed. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the components described herein, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A graphical user interface system, comprising:
a graphical component to enable sketching of a diagram;
a logical component to associate one or more data sources with the diagram; and
a visualization component to adjust the diagram in accordance with the one or more data sources.

2. The system of claim 1, the graphical component is associated with a mobile device, a desktop device, or an interactive surface.

3. The system of claim 1, the logical component determines a fit of at least one visualization form to a data set associated with the one or more data sources.

4. The system of claim 3, the logical component employs heuristics to determine the fit of the visualization form to the one or more data sources.

5. The system of claim 4, the heuristics includes a shape analysis to determine a suitable graphical form.

6. The system of claim 4, the heuristics includes a category or label analysis to associate a set of data to the visualization form.

7. The system of claim 4, the heuristics includes a cluster analysis to associated a set of data to the visualization form.

8. The system of claim 4, the visualization form includes graphs, charts, trees, multi-dimensional depictions, video displays, images, or hybrid presentations where output is segmented into multiple display areas.

9. The system of claim 8, the charts include pie charts, bar charts, linear graphs, non-linear graphs, or tables having one or more rows and one or more columns.

10. The system of claim 1, further comprising a variance tree to provide possible rendering outputs which can be selected by a user.

11. The system of claim 10, the variance tree includes different paths or branches for one or more possible visualization outcomes.

12. The system of claim 11, further comprising an intermediate rendering option of the different paths or branches selected where the user can select the intermediate rendering or return to a previous rendering.

13. The system of claim 1, further comprising an inference component to determine a potential rendering from a sketch and at least one data source.

14. The system of claim 1, further comprising a gesture component to analyze a user's intent and render a rough sketch from the determined intent.

15. The system of claim 14, further comprising a chart construction module to facilitate rendering of a rough sketch or a finalized diagram.

16. A graphical interface method, comprising:
rendering a primitive sketch of a diagram;
determining a data set for the diagram; and
automatically rendering a completed diagram from the determined data set.

17. The method of claim 16, further comprising employing heuristics or inferences to determine the data set.

18. The method of claim 16, further comprising employing heuristics or inferences to determine the completed diagram.

19. The method of claim 16, further comprising providing one or more feedback options of potential renderings to guide the completed diagram.

20. A visualization system, comprising:
means for rendering a generic outline of a diagram;
means for mapping one or more data sources to the diagram; and
means for generating a finalized diagram from the mapped data sources.
